(19) United States
(12) Patent Application Publication
(10) Pub. No.: US 2019/0331488 A1
(43) Pub. Date: Oct. 31, 2019

(54) LASER LEVEL DEVICE WITH REFERENCE MARKING

(71) Applicant: Fluke Corporation, Everett, WA (US)

(72) Inventors: Christopher D. Corrigan, Seattle, WA (US); Nelson M. Abaga, Lake Stevens, WA (US)

(21) Appl. No.: 15/963,979

(22) Filed: Apr. 26, 2018

(51) Int. Cl. G01C 15/00; G01B 11/26

(52) U.S. Cl. CPC G01C 15/004; G01B 11/26

(57) ABSTRACT

A laser level device with a marking feature indicates a relative position of the emitting light beam/ray with respect to a geometry of the housing of the laser level device. One or more of the outer surfaces of the laser level device includes a reference plane that provides a reference to measure a distance to the laser light beam. A distance of the light beam to the reference plane may be pre-marked on another outer surface of the laser level device, which is convenient for a user to check or mark the distance in a use scenario.

### BACKGROUND

### Technical Field

The present disclosure relates to optical devices, and more particularly, to laser level devices.

### Description of the Related Art

Conventional laser level devices typically generate laser lines by passing light rays through lens assemblies that include a plurality of lenses and mirrors. During the course of their work, users will frequently make reference measurements against the light beam emitted by such conventional laser level devices. The reference measurements are typically unintuitive and require additional user interpretation or customization depending on the job at hand.

### BRIEF SUMMARY

The techniques disclosed herein provide laser level devices with marking features that indicate a relative position of the emitting light beam/ray with respect to a geometry reference point of the housing of the laser level device. In one or more embodiments, one or more of the outer surfaces of the laser level device may each provide a reference plane that provides a reference to measure a distance of the laser light beam thereto. A distance of the light beam to a reference plane may be pre-marked on another outer surface of the laser level device, which may be adjacent to and meet with the outer surface providing the reference plane.

When in use, the laser level device may include a first surface providing a reference plane. The distance between the emitted light beam and the first surface is pre-marked on the laser level device and is easy to refer to. Elsewhere within the range of the laser level device, a distance between the emitted laser light beam and a second surface may be measured. The measured distance may be compared with the pre-marked distance such that a relative position between the first surface and the second surface, e.g., whether the first surface and the second surface are coplanar, can be determined based on the comparison result.

### BRIEF DESCRIPTION OF THE SEVERAL VIEWS OF THE DRAWINGS

FIG. 1A is a block diagram of a laser level device, according to one or more embodiments of the present disclosure.

FIG. 1B is a side view of a laser level device, according to one or more embodiments of the present disclosure.

FIG. 1C is a side view of a laser level device with a control panel of the laser level device shown in FIG. 1A, according to one or more embodiments of the present disclosure.

FIG. 1D is a front view of the laser level device shown in FIG. 1A, according to one or more embodiments of the present disclosure.

FIG. 2A is a two-point perspective view of a laser level device, according to one or more embodiments of the present disclosure.

FIG. 2B is another two-point perspective view of the laser level device shown in FIG. 2A, according to one or more embodiments of the present disclosure.

FIG. 3 is a side view of the laser level device of FIGS. 2A and 2B in a first use scenario, according to one or more embodiments of the present disclosure.

FIG. 4 is a top view of the laser level device of FIGS. 2A and 2B in a second use scenario, according to one or more embodiments of the present disclosure.

### DETAILED DESCRIPTION

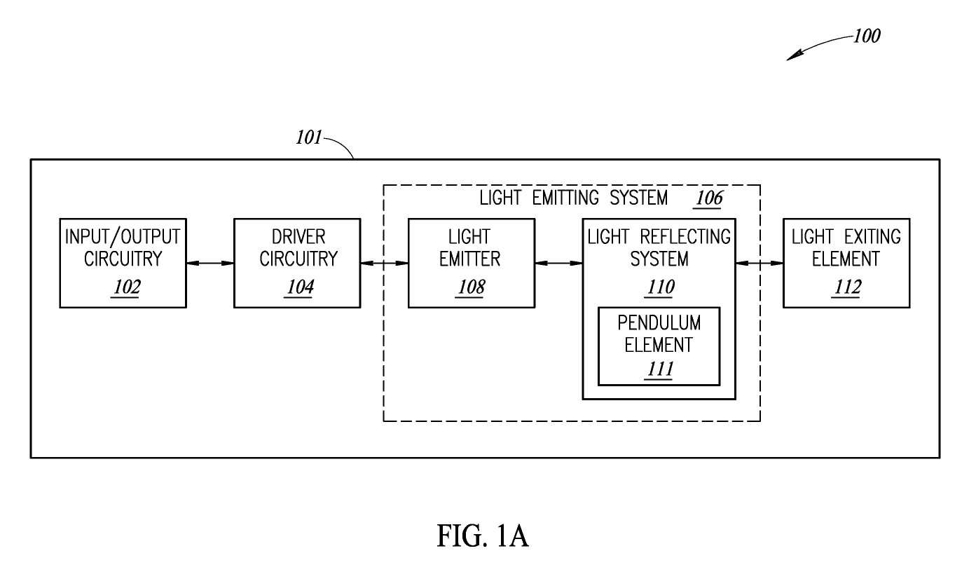

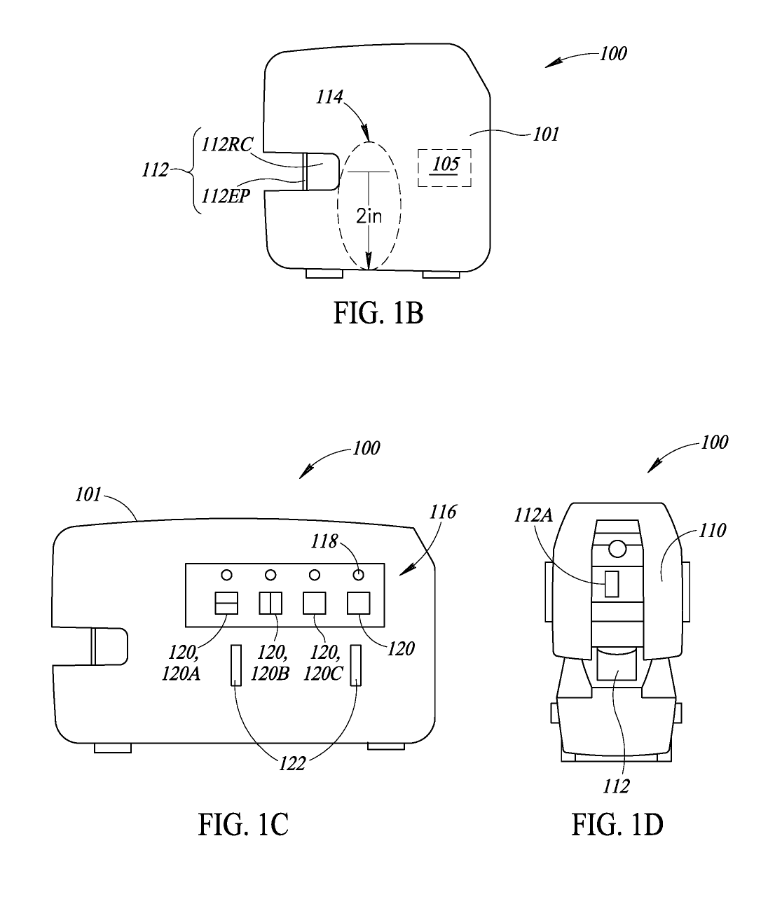

FIGS. 1A-1D show an example laser level device 100 according to one or more embodiments of the present disclosure. FIG. 1A is a block diagram and FIG. 1B is an example side view. With reference to FIGS. 1A and 1B together, the laser level device 100 includes a housing 101, and within the housing 101, an input/output circuitry 102, a driver circuitry 104 and a light emitting system 106. The light emitting system 106 includes a light emitter 108 and a light reflecting system 110, e.g., combination aspheric lens and axicon. The light reflecting system 110 may further include a pendulum element 111, which functions to maintain a plumb position of some elements of the light reflecting system 110 such that the output light beam is maintained either substantially plumb or substantially level independent of the position of the housing 101. A light exiting element 112 is exposed from the housing 101, through which a light beam exits the laser level device 100. The light exiting element 112 may include a light exiting panel 112EP and a reference checking feature 112RC. The light exiting panel 112EP may be a transparent window. The reference checking feature may be a transparent or semi-transparent element where a trajectory or direction of the light beam is shown. The laser level device 100 also includes a power supply (not shown). In one or more embodiments, the power supply includes one or more batteries, e.g., AA batteries.

In one or more embodiments, the input/output circuitry 102 includes one or more operator interface elements (e.g., buttons, switches, touch sensors) configured to receive input from an operator, and to control operation of the laser level device 100 in accordance with the input from the operator. The input/output circuitry 102 also may include a display screen (e.g., liquid crystal display screen) and/or one or more light emitting diodes (LEDs) that are configured to indicate to an operator a current configuration and/or operating status of the laser level device 100.

For example, with reference to FIG. 1C, which shows a sidewall of the laser level device 100 having an example control panel, the input/output circuitry 102 (not shown in FIG. 1D for simplicity) may include an LED(s) 118 and a switch(es) 120, among a plurality of control buttons 120. Switch 120 controls whether power is supplied to the light emitter 108 and the LED 118. When the switch 120 is in a first position, no power is supplied to the LED 118 or the light emitter 108. When the switch 120 is in a second position, power is supplied to the LED 118 and the light emitter 108, which causes the LED 118 and the light emitter 108 to emit light rays. Accordingly, illumination of the LED 118 indicates to an operator that the light emitter 108 is emitting light rays.

Control buttons 120 may also include a button 120A that controls the functioning of the pendulum element 111 to cause a light beam be exited in a substantially level direction. A button 1208 controls the functioning of the pendulum element 111 to cause a light beam be exited in a substantially plumb direction. A button 120C controls the pendulum element 111 to be either locked, in which the pendulum element 111 is functioning, or released, in which the pendulum element 111 is not functioning. When the pendulum element is released, the light reflecting system 110 causes a light beam to exit the light exiting element 112 in a direction parallel to at least one of the reference planes of the housing 101, as will be further described herein.

Multiple protruding features 122 may be included on the sidewall, which are further described in details herein.

Referring back to FIG. 1A, in one or more embodiments, the driver circuitry 104 includes resistors, preferably configured in a voltage divider configuration, that convert a voltage level output by the power supply into a voltage level appropriate for driving the light emitter 108. In one or more embodiments, the light emitter 108 is a semiconductor laser diode that produces visible light rays having a wavelength between 510-530 nanometers. The light emitter 108 may produce light rays having other wavelengths without departing from the scope of the present disclosure.

The light reflecting system 110, e.g., combination aspheric lens and axicon, is configured to route the generated light ray/beam to emit from the light exiting element 112 in a structured direction. The structured direction may be a direction parallel to a reference plane of the housing 101 and may be one of substantially plumb or substantially level independent of the position of the housing 101. For example, the pendulum element 111 may cause lenses and/or reflection surfaces of the light reflecting system 110 to be suspended within the housing 101 such that the light beam exiting the light exiting element 112 is one of plumb or level. In an embodiment, the pendulum element 111 may be locked or released, e.g., by control button 120C. When locked, the pendulum element 111 functions to maintain the light beam to be either plumb or level. When released, the pendulum element 111 does not function, and the light beam that exits the light exiting element 112 is in a direction substantially parallel to the geometry of the housing 101, i.e., the direction of the light beam is dependent and relative to the geometry and/or positioning of the housing 101.

The pendulum element 111 is provided as an example which does not limit the scope of the disclosure. Other approaches to achieve the self-leveling of the light beam, i.e., substantially level or substantially plumb, are also possible and included in the disclosure.

FIG. 1B is a side view of the example laser level device 100, according to one or more embodiments of the present disclosure. As will be explained in detail herein, the housing 101 includes a marking element 114 that indicates a distance, shown as two inches, “2 in”, for an illustrative example, between the light beam to a reference plane provided by the geometry of the housing 101 before or upon the light beam exiting the light exiting element 112. When the light beam is parallel to the reference plane, the distance should be the same before and after the light beam exits the light exiting element 112.

FIG. 1C is a view of a control panel 116 of the laser level device 100, according to one or more embodiments of the present disclosure. In one or more embodiments, the laser level device 100 includes an control panel 116 with a plurality of LEDs 118 and a plurality of switches 120, which are part of or coupled to the input/output circuitry 102 described above. Further details of the control panel 116 are described elsewhere herein.

FIG. 1D is an example front view of the laser level device 100. In one or more embodiments, the laser level device 100 may include a second light emitting system (not shown for simplicity), which may have the same configurations as the light emitting system 106 as shown in FIG. 1A. A second light exiting element 112A may work with the second light emitting system, wherein the second light emitting system emits light rays that exit the laser level device 100 through the second light exiting element 112A. A laser light beam formed by the second light emitting system may be perpendicular to a laser light beam formed by the first light emitting system 106. Accordingly, a laser level device 100 having the above configuration can generate a first laser light beam that provides a plumb line (i.e., vertical line) and a second laser light beam that provides a level line (i.e., horizontal line), which is perpendicular to the plumb line. Further, the second light emitting system may operate with a different operation mode from the light emitting system 106. For example, the second light emitting system may emit a light in a pendulum element locked mode, and light emitting system 106 may emit a light in a pendulum element 111 released mode. Alternatively or additionally, the light reflecting system 110 may be configured to reflect the laser light beam to exit device 100 either in a plumb line (vertical line) or in a level line (horizontal line) controlled by a mode selection button 120.

All such various configurations of the light emitting system 106 to generate and emit laser light beams are possible and included in the disclosure, and none of them are limiting the scope of the disclosure.

In the description herein, a device 100 having one light emitting system 106 and one light exiting element 112 is used as an illustrative example to describe the embodiments of the marking element 114.

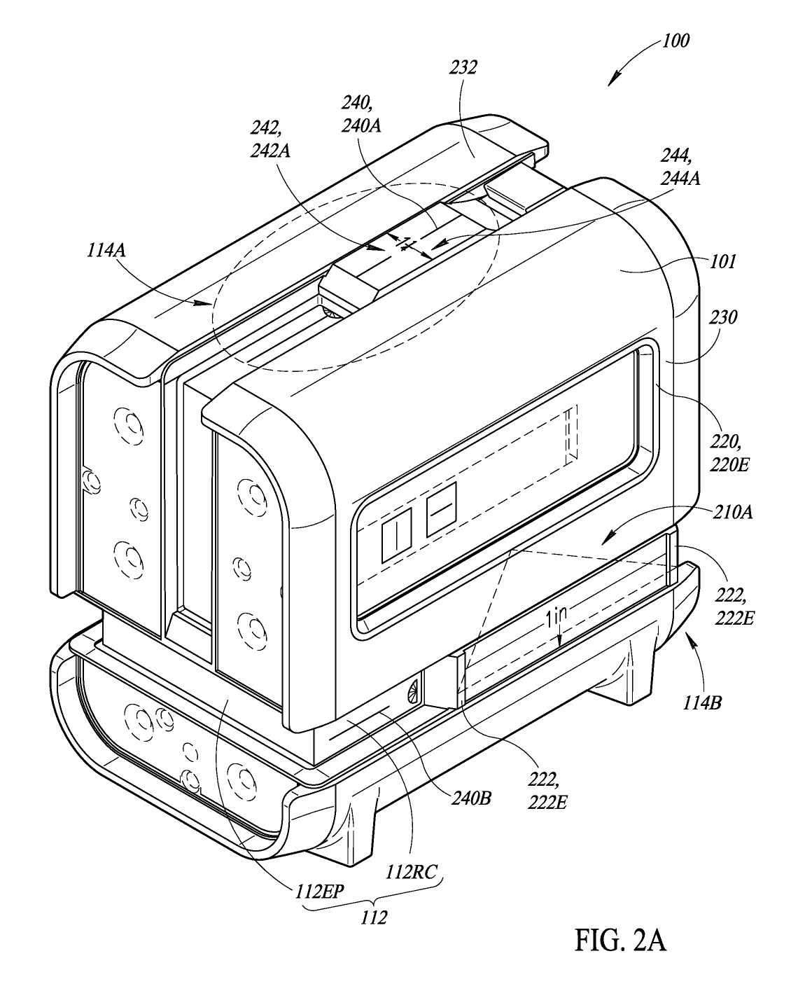

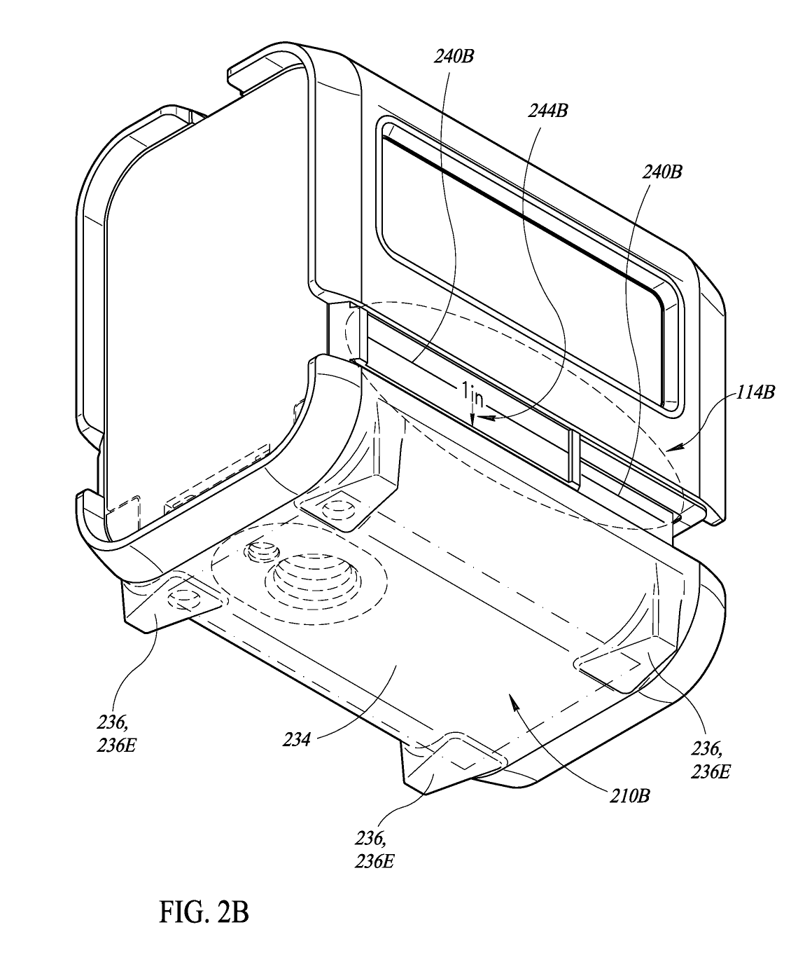

FIG. 2A is a two-point perspective view of an example laser level device 100 from top and front perspectives, and FIG. 2B is a two-point perspective view of an example laser level device 100 from bottom and rear perspectives. Referring to FIGS. 2A and 2B together, the housing 101 of the laser level device 100 includes a first reference plane 210A and a second reference plane 210B. Each reference plane 210A, 210B includes at least three outermost or edge points that protrude outward from the housing 101 and are arranged in a triangle or rectangle configuration. For example, as shown in FIG. 2A, the reference plane 210A is formed by a protruding peripheral portion 220 of control panel 116 and two dedicated protruding elements 222. The protruding peripheral portion 220 has an edge surface 220E, and the dedicated protruding elements 222 each have an edge surface 222E. The three edge points are included or integrated on the edge surfaces 220E and 222E, respectively. Note that a planar edge surface 220E, 222E each can be viewed as including a plurality of edge points. The edge surfaces 220E and 222E are configured to be the outermost points of a sidewall 230 of the housing 101, and are substantially co-planar with one another at the reference plane 210A.

Marking element 114A is located on a top surface 232 of the housing 101. The top surface 232 is adjacent to and meets with the sidewall 230 where the reference plane 210A is located. In an example, as shown in FIG. 2A, marking element 114A includes a reference line 240A which is substantially parallel to the reference plane 210A, a mark 242A, here shown as “1¼”, indicating a distance between the laser light beam and the reference plane 210A, and an arrow 244A indicating the respective reference plane 210A of the marking element 114A. For example, the marking element 114A includes two arrows 244A directing to the sidewall 230 and the opposite sidewall, respectively, which indicate that the laser light beam is positioned in the middle of the two opposite sidewalls and is spaced equally to the two sidewalls at a distance of 1¼ inch.

As shown in FIG. 2B, the reference plane 210B is included on a bottom or lower surface 234 of the housing 101 and is formed by four protruding elements 236, designed to act as feet that support the device 100 in an upright position. The edge points are included or integrated on the edge surfaces or bottom surfaces 236E of the four protruding elements 236. The edge surfaces 236E are configured to be the outermost points of the bottom surface 234 of the housing 101 and are substantially co-planar with one another at the reference plane 210B. FIG. 2B shows four protruding elements 236 for illustration. Other numbers of protruding elements 236 are also possible and included in the disclosure. For example, two adjacent protruding elements 236 may be formed together as a single piece having a single edge surface 236E, and bottom surface 234 may thus include two protruding elements 236, each including a larger edge surface 236E. The two bottom surface protruding elements 236 may each extend substantially from one sidewall 230 to another opposite sidewall of the housing 101. Note that as long as the coplanar edge surfaces 236E are sufficiently large (to provide a stable reference plane), the three outermost points may be included in a single edge surface 236E, or in two or more edge surfaces 236E, which are all included in the disclosure.

Marking element 114B, corresponding to the reference plane 210B, is located on the sidewall 230 of the housing 101. The sidewall 230 is adjacent to and meets with the bottom surface 234 where the reference plane 210B is located. In an example, as shown in FIG. 2B, marking element 114A includes a reference line 240B which is substantially parallel to the reference plane 210B, a mark 242B, here shown as “1 in”, indicating a one-inch distance between the laser light beam and the reference plane 210B before and/or upon the light beam exiting the light exiting element 112, and an arrow 244B indicating the respective reference plane 210A. For example, marking element 114B includes one arrow 244B directing to the bottom surface 234. In this example, the top surface 232 of the housing 101 is not used as a reference plane, which is not limiting. Any surfaces of the housing 101, except for the light emitting surface, here the front surface of housing 101 as an illustrative example, may include a reference plane, and all are included in the disclosure.

The reference line 240A, 240B is so positioned such that the laser light beam at least partially overlaps with the reference line 240A, 240B. As described herein, the laser level device 100, or specifically the light emitting system 106, includes two modes of directing the laser beam—self-leveling mode or fixed mode. In the self-leveling mode, the light emitting system 106 emits a laser light beam, through light exiting element 112, in the direction of one of substantially level or substantially plumb, independent of whether the housing 101 is set level or plumb. In the self-leveling mode, the laser light beam may still be parallel to at least one reference panel. In the fixed mode, the light beam is parallel to at least one reference plane 210A and/or 210B. In the fixed mode, the light beam fully overlaps with the reference line 240A corresponding to the reference plane 210A to which the light beam is parallel. For example, in the case that the light beam is parallel to the reference plane 210A, the light beam fully overlaps with reference line 240A of the marking element 114A corresponding to the reference plane 210A. In the self-leveling mode, the laser light beam may still be parallel to at least one reference plane. For example, in the case that a substantially level light beam is output, the light beam may not be parallel with a reference plane of the top surface or bottom surface of the housing 101, due to the self-leveling, but is still parallel to the reference plane 210A of sidewall 230, which is not affected by the self-leveling.

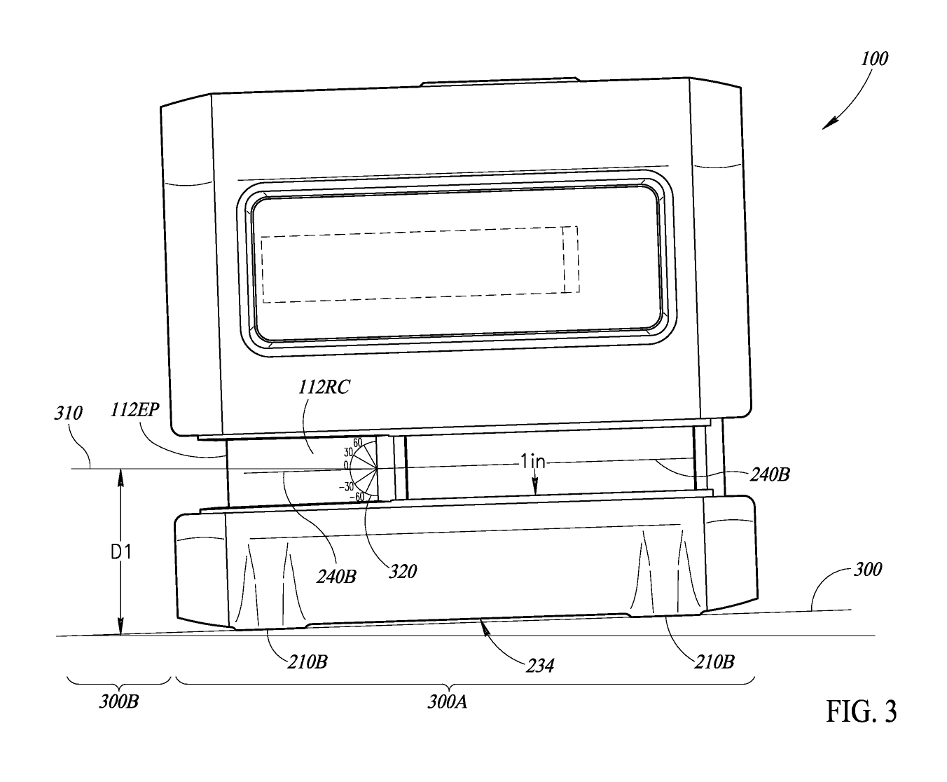

Further, in the case that the light beam is not parallel to a reference surface 210 due to the self-leveling function, e.g., the pendulum element 111 is set to function, the reference line 240 may be used to indicate the extent to which the light beam deviates from the parallel reference line 240. For example, with reference to FIG. 3, in the case that the laser level device 100 is set on a sloped floor 300 with reference plane 2108 on the bottom surface 234, with the pendulum element 111 (not shown in FIG. 3) functioning, a substantially level laser light beam 310 may deviate from the reference line 240B of the marking element 114B, which is in parallel with the reference plane 210B setting on the sloped surface 300.

The deviation of the level light beam 310 and the reference line 240B may be used to indicate an angle of the sloped surface 300.

To this extent, the reference checking element 112RC of the light exiting element 112 may be used to facilitate the checking of the relative position of the light beam against the reference line 240. In one or more embodiments, as shown in FIG. 3, the reference line 240B may be marked on the reference checking element 112RC of the light exiting element 112 such that a user can easily check and/or evaluate the deviation between the substantially level light beam 310 and the reference line 240B. Further, the marking element 114, e.g., 114B, may also include an angle marking 320 that indicates an extent of the deviation between the light beam 310 and the reference line 240B, e.g., through pre-marked angles.

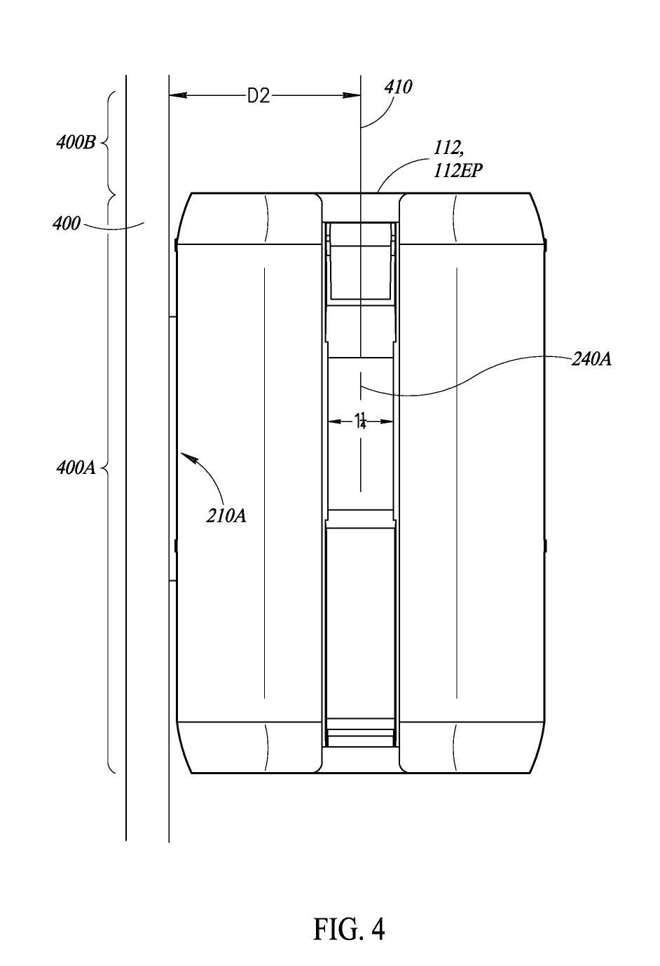

FIG. 3 shows an example operation scenario in which the laser level device 100 is set on a horizontally-oriented surface 300 with the reference plane 210B on the bottom surface 234 of the housing 101. FIG. 4 shows another example operation scenario in which the laser level device 100 is positioned with respect to a vertically-oriented surface 400 in which the reference plane 210A of the sidewall 230 of the housing 101 is adjacent the surface 400.

Referring to FIGS. 3 and 4 together, in an operation scenario, with the laser level device 100 provided, a user sets or attaches the laser level device 100 to a first surface, e.g., a first portion 300A of the horizontally-oriented surface 300 of FIG. 3, or a first portion 400A of the vertically-oriented surface 400, with the outer reference plane 2108, 210A, respectively. The user operates the laser level device 100 to emit the light beam 310, 410 that is one or more of substantially level, substantially plumb (not shown), or substantially parallel to at least one of the outer reference planes 2108, 210A. A measured distance D1, D2 between the light beam 310, 410 and a second surface, e.g., second portions 300B, 400B of the horizontal surface 300 or the vertical surface 400, respectively, is compared with the marked distance of the marking element 114B, 114A to determine a relative position between the second surface 300B, 400B to the first surface 300A, 400A, respectively.

Further, the emitted light beam 310 may be compared to the reference line 240B to determine whether the first surface 300A is level or plumb. Note that in FIG. 4, the light beam 410 is substantially parallel to the reference line 240A because the self-leveling function does not affect the laser line direction with respect to the sidewall of the laser level device 100.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A laser level device, comprising:
a housing having a first outer reference plane and a second outer reference plane;
a light exiting element exposed from the housing; and
a light emitting system within the housing;
wherein the light emitting system is configured to generate a light beam that exits the light exiting element in a direction substantially parallel to at least one of the first outer reference plane or the second outer reference plane; and
wherein the housing includes a marking element indicating a distance of the light beam to the at least one of the first outer reference plane or the second outer reference plane.

2. The laser level device according to claim 1, wherein the first outer reference plane is provided by a sidewall of the housing.

3. The laser level device according to claim 2, wherein the marking element includes a mark on a top surface of the housing indicating a distance of the light beam to the first outer reference plane.

4. The laser level device according to claim 2, wherein the first outer reference plane includes at least three protruding elements that protrude from the sidewall of the housing, the at least three protruding elements each including an edge point configured to be an outermost point of the sidewall.

5. The laser level device according to claim 4, wherein the three protruding elements each including an edge surface that includes the respective edge point, the edge surfaces being substantially coplanar with one another.

6. The laser level device according to claim 4, wherein one of the three protruding elements is a peripheral portion of a control panel of the laser device.

7. The laser level device according to claim 1, wherein the second outer reference plane is provided by a lower surface of the housing.

8. The laser level device according to claim 7, wherein the marking element includes a mark on a sidewall of the housing indicating a distance of the light beam to the second outer reference plane.

9. The laser level device according to claim 7, wherein the second outer reference plane includes at least two protruding elements that protrude from the lower surface of the housing, the at least two protruding elements each including a bottom point configured to be a lowest point of the lower surface.

10. The laser level device according to claim 9, wherein the at least two protruding elements each include a bottom surface that includes the respective bottom point, the at least two bottom surfaces being substantially coplanar with one another.

11. The laser level device according to claim 10, wherein the at least two protruding elements each extend substantially from one sidewall to another opposite sidewall of the housing.

12. The laser level device according to claim 1, wherein the marking element includes a reference line indicating a parallel position of the light beam relative to the at least one of the first outer reference plane or the second outer reference plane.

13. The laser level device according to claim 12, wherein the light emitting system is configured to generate a light beam in alignment with the reference line in a case that the light beam is parallel to the at least one of the first outer reference plane or the second outer reference plane.

14. The laser level device according to claim 13, wherein the light exiting element includes an alignment checking feature.

15. The laser level device according to claim 14, wherein the marking element further includes an angle mark indicating an angle between the light beam and the reference line.

16. The laser level device of claim 1, wherein the light emitting system is further configured to generate a light beam that exits the light exiting element in a direction of one of substantially level or substantially plumb.

17. The laser level device of claim 16, wherein the marking element indicates a distance of the light beam to the at least one of the first outer reference plane or the second outer reference plane before or upon the light beam exiting the light exiting element.

18. A laser level device, comprising:
a housing having a first outer reference plane and a second outer reference plane;
a light exiting element exposed from the housing; and
a light emitting system within the housing;
wherein the light emitting system is configured to generate a light beam that exits the light exiting element in a direction one of substantially level or substantially plumb; and
wherein the housing includes a marking element indicating a distance of the light beam to at least one of the first outer reference plane or the second outer reference plane before or upon the light beam exiting the light exiting element.

19. The laser level device of claim 18, wherein the marking element includes a reference line that is parallel to one of the first outer reference plane and the second outer reference plane, and
wherein the light emitting system is further configured to generate the light beam that at least partially overlaps the reference line before or upon exiting the light exiting element.

20. A method, comprising:
providing a laser level device, the laser device including a housing having an outer reference plane, a light exiting element exposed from the housing, and a light emitting system within the housing that is configured to generate a light beam that exits the light exiting element in a direction one of substantially in parallel to the outer reference plane, substantially level, or substantially plumb, and the housing including a marking element indicating a marked distance of the light beam to the outer reference plane before or upon the light beam exiting the light exiting element;
positioning the laser device to a first surface that is adjacent to the outer reference plane;
operating the laser level device to emit the light beam;
determining a measured distance between the light beam and a second surface; and
determining a relative position between the first surface and the second surface by comparing the measured distance with the marked distance.
